(19) United States
(12) Patent Application Publication
(10) Pub. No.: US 2007/0121190 A1
(43) Pub. Date: May 31, 2007

(54) Display

(75) Inventors: Erwin Rinaldo Meinders, Eindhoven (NL); Johannes Theodorus Adriaan Wilderbeek, Eindhoven (NL); Martinus Bernardus Van Der Mark, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/576,314

(22) PCT Filed: Oct. 13, 2004
(86) PCT No.: PCT/IB04/03381

§ 371 Date: Apr. 18, 2006

(30) Foreign Application Priority Data
Oct. 21, 2003 (EP) 03300174.4

(51) Int. Cl. G02F 1/15

(52) U.S. Cl. 359/265

(57) ABSTRACT

The present invention relates to a display for displaying pre-recorded images. The display comprises at least one image stack comprising at least one image sub-stack (13, 14, 15). The image sub-stack comprises a material which optical properties depend on a potential difference (V1) applied between two electrodes (13, 15), wherein said image sub-stack can be locally altered in order to record an image.

### FIELD OF THE INVENTION

The present invention relates to a display for displaying pre-recorded images.

The present invention also relates to a method of recording an image in such a display, a cartridge for recording such a display and a cartridge for displaying images recorded in such a display.

The present invention is particularly relevant for displaying pre-recorded images, such as for commercials, post-cards or labels.

### BACKGROUND OF THE INVENTION

Amongst all kind of displays used nowadays, electrochromic displays are currently under investigation. An electrochromic display comprises cells comprising an electrochromic material. Each cell represents a pixel of the display, which comprises a layer comprising said electrochromic material, an electrolyte and a counter electrode. By applying a potential difference between said layer and said counter electrode, the color of the electrochromic material can be changed. As a consequence, by varying independently the color of each cell, an image can be created and thus displayed. However, this requires applying different potential differences to each cell in order to independently address each cell, which means that such a display comprises a relatively large number of electrical contacts, for example one million electrical contacts. Moreover, independently addressing each cell requires complicated and power consuming electronics, such as a microprocessor which, depending on the image to be displayed, addresses the adequate cells. Such a complicated and thus costly display cannot be used advantageously in many applications, such as a postcard, a photo frame or commercials.

U.S. Pat. No. 6,598,966, published Jul. 29, 2003, describes an electrochromic display, in which the image to be displayed is pre-recorded by means of an electrochromic ink. In order to display the pre-recorded image, a potential difference is applied between the layer comprising said pre-recorded image and a counter electrode. As a consequence, the number of required contacts is reduced, and the required electronics are less complicated, which makes it possible to use such a display for low-cost products. However, recording an image in such a display requires a computer printer, as well as electrochromic ink. Moreover, the method for recording an image requires applying and assembling different layers in the display. As a consequence, recording an image in such a display is relatively difficult.

### SUMMARY OF THE INVENTION

It is an object of the invention to provide a display in which images can be more easily recorded.

To this end, the invention proposes a display for displaying pre-recorded images, said display comprising at least one image stack comprising at least one image sub-stack, said image sub-stack comprising a material which optical properties depend on a potential difference applied between two electrodes, wherein said image sub-stack can be locally altered in order to record an image.

According to the invention, an image created in the display results from the alteration of a sub-stack of the display. As a consequence, a display in accordance with the invention does not require use of a printer and electrochromic ink. Moreover, in certain embodiments of the invention, the different layers of the display can be assembled prior to altering a sub-stack of said display in order to record an image. This makes recording of an image in such a display easier.

The invention also relates to a display for displaying pre-recorded images, said display comprising at least one image stack comprising at least one image sub-stack, said image sub-stack comprising a material which optical properties depend on a potential difference applied between two electrodes, wherein said image sub-stack is locally altered in order to record an image which can be displayed by applying said potential difference between said two electrodes.

In a first embodiment of the invention, the material is an electrochromic material. Such an electrochromic material is particularly advantageous, because it can be embedded in a flexible layer, hence leading to a flexible display. Moreover, use of an electrochromic material in a display in accordance with the invention allows recording and displaying colored images. Furthermore, a display using an electrochromic material has a relatively low power consumption, as will be explained in more detail in the following.

An electrochromic material has an ability to take up or release electrons. Preferably, the ability to take up or release electrons of the electrochromic material can be locally reduced by means of an optical beam. An image can be recorded by means of an optical beam, such as a laser used in a conventional optical scanning device. This makes recording of an image relatively easy for a user having an optical scanning device, which is the case for most of the people.

Advantageously, the at least one image stack comprises at least two image sub-stacks comprising electrochromic materials having different optical properties. It is then possible to record and display images having a relatively large number of different colors, as will be explained in more detail in the following.

In a second embodiment of the invention, the display further comprises a color filter. Colored images can then be recorded and displayed.

Advantageously, the color filter comprises pixels having different colors. It is then possible to record and display images having a relatively large number of different colors, as will be explained in more detail in the following.

In a preferred embodiment, the display comprises at least two image stacks. According to this preferred embodiment, different images can be recorded in the display. As the images can be displayed independently of each other, it is possible to display the images one after the other. This might be useful, for example, for creating a photo frame. Alternatively, the images can be displayed one after the other in a relatively fast way, thus giving the impression of movement. Alternatively, the images can be displayed simultaneously, thus giving the impression of three dimensions.

The invention also relates to a method for recording an image in a display as described above, said method comprising a step of locally altering said at least one image sub-stack in order to record an image.

Preferably, the altering step comprises a sub-step of focusing an optical beam on the at least one information sub-stack.

The invention also relates to a cartridge for recording an image in a display as described above, said cartridge comprising means for receiving said display, means for receiving a signal comprising information about a selected image sub-stack and means for applying a potential difference between the two electrodes of said selected image sub-stack.

The invention also relates to a cartridge for displaying an image in a display as described above, said cartridge comprising means for receiving said display, means for selecting an image sub-stack and means for applying a potential difference between the two electrodes of the selected image sub-stack.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIGS. 1a and 1b show a display in accordance with a first embodiment of invention, where no image is recorded;

FIGS. 2a and 2b show the display of FIG. 1 comprising an image;

FIG. 3 shows a display in accordance with another embodiment of the invention, where no image is recorded;

FIGS. 4a and 4b show the display of FIG. 3 comprising an image;

FIG. 5 shows a display in accordance with a first embodiment invention, comprising one image stack and three image sub-stacks;

FIG. 6 shows a display in accordance with the invention, comprising two image stacks.

FIG. 7 shows a cartridge for recording an image in a display in accordance with the invention;

FIG. 8 is a block diagram showing the functioning of the cartridge of FIG. 7;

FIG. 9 shows a cartridge for displaying an image in a display in accordance with the invention.

### DETAILED DESCRIPTION OF THE INVENTION

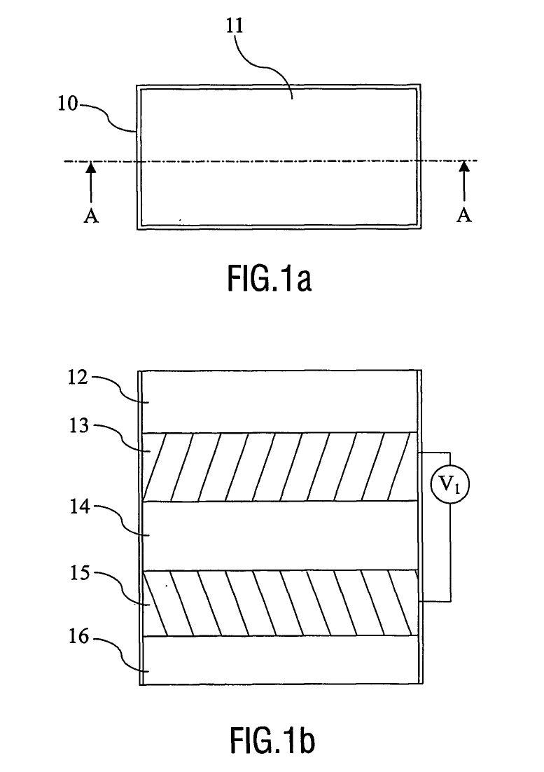

FIG. 1a shows a display in accordance with the invention. Such a display 10 comprises an image area 11. FIG. 1b is a cross section of the display 10 in a plane AA of FIG. 1a. The image area 11 comprises a cover 12, an electrochromic layer 13, an electrolyte layer 14, a counter electrode 15 and a substrate 16.

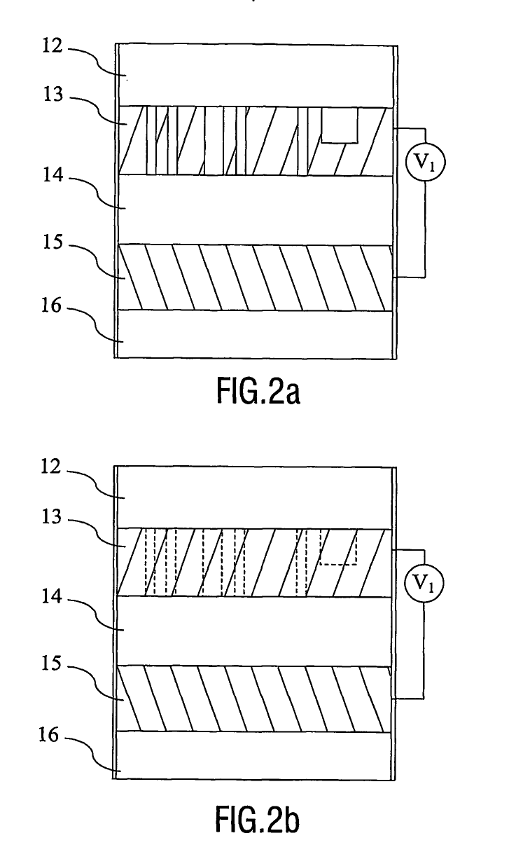

In the example of FIG. 1b, the display 10 comprises only one image stack, comprising only one image sub-stack. The image sub-stack comprises the electrochromic layer 13, the electrolyte layer 14 and the counter electrode 15. An image can be recorded in said sub-stack, as explained in more detail in FIGS. 2a and 2b. This image can be displayed to a user through the cover 12, which is preferably transparent.

Such a display 10 can be used in a reflective way. In this case, light coming from the outside through the cover 12 is reflected from the sub-stack to a user when an image is displayed. Alternatively, the display 10 is used in a transmissive way. In this case, an additional light is preferably provided in the display, which is adapted for providing light through the substrate 16, which light then passes through the counter electrode 15, the electrolyte 14, the electrochromic layer 13 and the cover 12 for reaching the user. Alternatively, the display 10 is used in a transflective way, which is a combination between reflective and transmissive.

The electrochromic layer 13 comprises an electrochromic material. An electrochromic material is a material having optical properties, which can change as a result of electron uptake or loss. Electrochromic materials are known from those skilled in the art. For example, the publication “Electrochromism: Fundamentals and Applications”, written by Paul M. S. Monk et. al. and published in 1995, describes the properties of electrochromic materials. For example, the electrochromic material is a thiophene derivative, such as poly(3,4-ethylenedioxythiophene), also called PEDT or PEDOT and described, for example, in “Poly(3,4-ethylenedioxythiophene) and Its Derivatives: Past, Present and Future”, by L. Bert Goenendaal et. al., published in Advanced Materials 2000, 12, No. 7.

In the example of FIG. 1b, the electrochromic material has a reduced state and an oxidized state. The electrochromic material is chosen to be colored when it is in its reduced state, and transparent when it is in its oxidized state. Of course, another electrochromic material could be used, which is colored when it is in its oxidized state, and transparent when it is in its reduced state.

When a potential difference V1 is applied between the electrochromic layer 13 and the counter electrode 15, the electrochromic layer 13 being at a higher potential than the counter electrode 15, a current flows from the electrochromic layer 13 to the counter electrode 13, whereas electrons are transported from the counter electrode 15 to the electrochromic layer 13. Electrons are absorbed by the electrochromic material, which becomes reduced. For reasons of electrical neutrality, positive ions from the electrolyte layer 14 are absorbed by the electrochromic layer 13 or negative ions are expelled by the electrochromic layer 13, and negative ions from the electrolyte 14 are absorbed by the counter electrode 15 or positive ions are expelled by the counter electrode 15. Hence, the counter electrode 15 is an ion-accepting and donating electrode.

The required potential difference V1 depends on the electrochromic material, the electrolyte, the counter electrode 14, and optional additional electrode in the information stack.

As a consequence, applying a potential difference between the electrochromic layer 13 and the counter electrode 15 allows changing the color of the electrochromic layer 13. In the example of FIGS. 1a and 1b, the display 10, when used in a reflective way, is transparent when no potential difference is applied and has the color of the electrochromic layer when a suitable potential difference is applied. It should be noted that said color is maintained even if the potential difference is cut. Actually, the used electrochromic material displays bistability, which means that his optical properties persist when no potential difference is applied. This is advantageous, because the power consumption of a display in accordance with the invention is reduced.

It should be noted that the display 10 might comprise additional electrodes. For example, the display 10 might comprise a first additional electrode placed between the cover 12 and the electrochromic layer 13, and a second additional electrode placed between the counter electrode 15 and the substrate 16. In this case, the potential difference V1 is applied between the first and the second electrode. These electrodes are preferably chosen transparent. A suitable material for this electrode is, for example, ITO (Indium Tin Oxide).

The electrolyte layer 14 comprises an electrolyte, which should be able to provide ions to the electrochromic layer 13 and the counter electrode 15. Preferably, solid or elastomeric polymeric electrolytes are used in a display in accordance with the invention. These electrolytes consist of polymers comprising ion-labile groups, or consist of polymers with dissolved salts. Examples of polymers with dissolved salts are crosslinked polyethers, polyethylene oxide, polyvinyl alcohol or polymethyl methacrylate, with salts such as lithium chlorate, triflic acid or phosphoric acid.

It should be noted that the thicknesses of the layers represented in FIG. 1b are for illustration only, and might not correspond to the reality. As an example, the cover 12 might be 0.5 centimetres thick, whereas the electrochromic layer 13 is preferably a few hundred nanometres thick.

FIG. 2a shows the display 10, in which an image is recorded. In the example of FIG. 2a, an image is recorded by patterning the electrochromic layer 13. Patterning the electrochromic layer 13 can be performed by means of conventional means, such as photolithography using a mask representing the image to be recorded. The patterned electrochromic layer 13 comprises holes, which are represented by white rectangles in FIG. 2a. The depth of the holes might correspond to the thickness of the electrochromic layer 13, or might be less that said thickness.

When no potential difference is applied between the electrochromic layer 13 and the counter electrode 15, the electrochromic layer 13 is transparent, and a user cannot see any image in the display 10. When a suitable potential difference V1 is applied between the electrochromic layer 13 and the counter electrode 15, the electrochromic layer 13 becomes colored, except where holes have been created. The color depends on the chosen electrochromic material, as well as the thickness of the electrochromic layer 13. If the depth of a hole is less than the thickness of the electrochromic layer 13, the intensity of color where said hole has been created is reduced compared to the intensity of the color of the surrounding electrochromic material.

As a consequence, the recorded image appears to the user. If the potential difference is cut, the image remains, thanks to the bistability of the electrochromic material. The image can then be removed by applying a reverse potential difference between the electrochromic layer 13 and the counter electrode 15. In this case, the electrochromic material of the electrochromic layer 13 becomes oxidized, in which state it is transparent. As a consequence, the electrochromic layer 13 becomes transparent, and the user cannot see any image. If the image has to be displayed later, the potential difference V1 will again be applied between the electrochromic layer 13 and the counter electrode 15.

FIG. 2b also shows the display 10, in which an image is recorded. In the example of FIG. 2b, an image is recorded by means of an optical beam. The electrochromic material has an ability to take up or release electrons, which can be locally reduced by means of an optical beam. In order to locally reduce the ability to take up or release electrons of the electrochromic material, a relatively high power of the optical beam is required. The high power is absorbed in the material and changes its material properties, for example by melting, annealing, photochemical reactions, thermal damaging or deterioration.

In order to record an image in the display 10, the optical beam is focussed on the electrochromic layer 13, in order to locally reduce the ability to take up or release electrons of the electrochromic material, for writing marks. In FIG. 2b, the marks where the ability to take up or release electrons of the electrochromic material is reduced are represented by dotted lines. The depth of the marks in the electrochromic layer 13 can be chosen by varying the power of the optical beam, or by varying the time during which the optical beam is focussed on a mark.

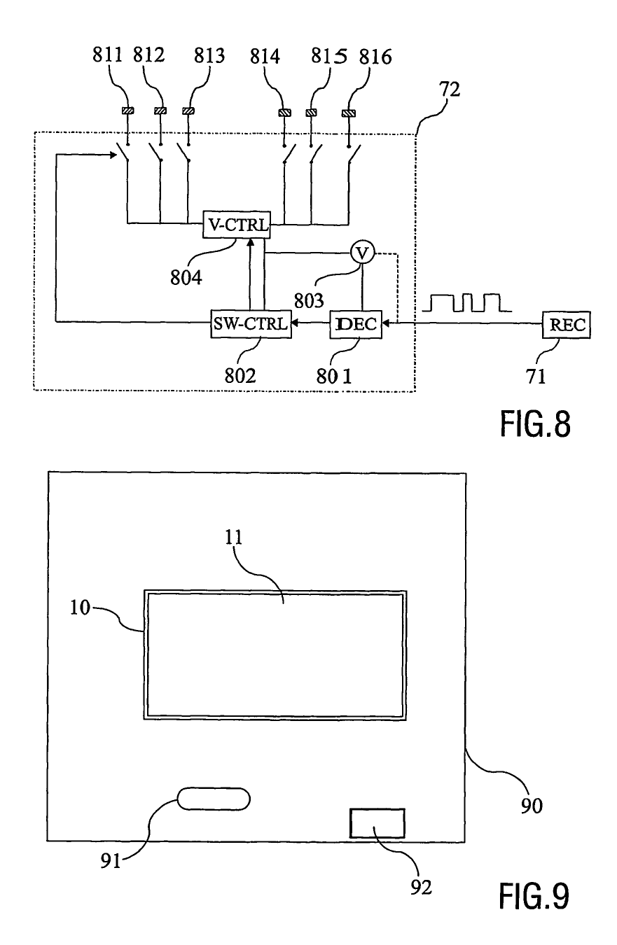

This can be performed by means of an optical scanning device, such as a CD recorder. Marks are written in the electrochromic layer 13, which marks represent the image to be recorded. This can be performed by means of a software, which converts the to be recorded image to sequences of laser pulses. The electrochromic layer 13 might be made colored before focussing the relatively high power optical beam on it. This improves absorption of the relatively high power optical beam, which increases the reduction of the ability to take up or release electrons of the electrochromic material. Recording an image in such a display is described in more detail in FIGS. 7 and 8.

In order to display the recorded image, a suitable voltage V1 is applied between the electrochromic layer 13 and the counter electrode 15. The electrochromic layer 13 becomes colored, except where marks have been written, because the ability to take up or release electrons of these marks is too small for allowing a reduction of the electrochromic material of these marks. Hence, the image is displayed.

As explained in FIG. 2a, the image can be removed by applying a reverse potential difference, and can be again displayed by applying the potential difference V1.

It should be noted that an optical beam with a higher power might be used, which is able to locally destroy the electrochromic layer 13. In this case, a patterned electrochromic layer 13 is obtained and the description of FIG. 2a applies.

It should also be noted that the width of the hole and marks in FIGS. 2a and 2b, respectively, are for illustration purpose only. Depending on the image to be recorded, the width of the holes and mark can vary. For example, if the image to be recorded is complex, the width of a mark might be a few micrometers whereas the width of the display might be a few centimetres or meters. Moreover, a pixel of the recorded image might comprise a plurality of marks, such as one hundred marks, depending of the available size of a mark and the size of a desired pixel in the image.

In the examples of FIGS. 2a and 2b, holes and marks are created where the image has to be recorded. It should be noted that holes and marks might be created where no image has to be recorded. In this case, the image will appear colored, whereas the image appears transparent in the examples of FIGS. 2a and 2b.

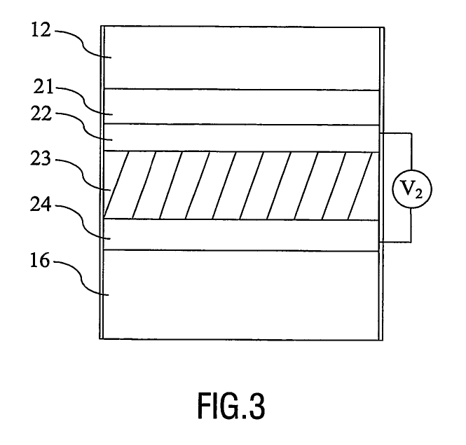

FIG. 3 shows another display in accordance with the invention. Such a display comprises the cover 12, a polarizer 21, a first electrode 22, a liquid crystal layer 23, a second electrode 24 and the substrate 16. The liquid crystal layer 23 comprises a liquid crystal material. Instead of a liquid crystal material, other materials comprising molecules which can be rotated when a suitable potential difference is applied between the first and second electrodes 22 and 24 could be used. For example, molecules comprising a charged substituent which can be rotated when subjected to a current created by the potential difference applied between the first and second electrodes could be used.

In the example of FIG. 3, the display comprises only one image stack, comprising only one image sub-stack. The image sub-stack comprises the first electrode 22, the liquid crystal layer 23 and the second electrode 24.

Liquid crystal molecules are described, for example, in “Handbook of Liquid Crystal Research”, written by Peter J. Collings, Jay S. Patel, Oxford University Press, New York, 1997. For example, when a suitable potential difference is applied between the first and second electrodes 22 and 24, an electrical field is created, which electrical field has a direction substantially orthogonal to the first and second electrodes 22 and 24. When subjected to this electrical field, the liquid crystal molecules of the liquid crystal layer 23 turn towards the direction of the electrical field.

Light coming from the outside through the cover 12 is polarized by means of the polarizer 21. As is well known from those skilled in the art, a liquid crystal layer appears either transparent or colored when polarized light passes through, depending on the orientation of the liquid crystal molecules. In this example, the initial orientation of the liquid crystal molecules of the liquid crystal layer 23 and the polarizer are chosen in such a way that the liquid crystal layer 23 appears transparent when no potential difference is applied, and colored when a suitable potential difference is applied.

It should be noted that the polarizer 21 should be placed between the substrate 16 and the second electrode 24, in case the display of FIG. 3 is used in a transmissive way.

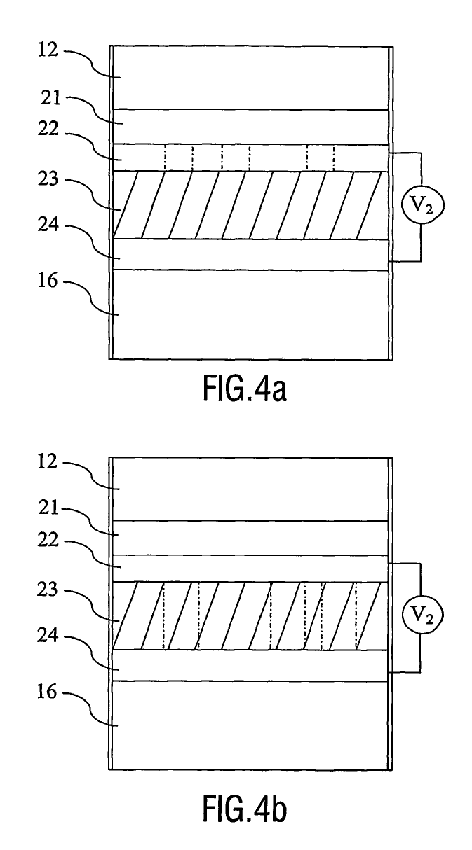

FIGS. 4a and 4b show the display of FIG. 3, in which an image is recorded. In the examples of FIGS. 4a and 4b, an image is recorded by means of an optical beam.

In FIG. 4a, the first electrode 22 has an electrical conductance which can be locally reduced by means of the optical beam. In order to locally reduce the electrical conductance of the first electrode 22, a relatively high power optical beam is required. The high power is absorbed in the material and changes its material properties, for example by melting, annealing, photochemical reactions, thermal damaging or deterioration.

In order to record an image, the optical beam is focussed on the first electrode 22, in order to locally reduce the electrical conductance of this first electrode 22, for writing marks. In FIG. 4a, the marks where the electrical conductance of the first electrode 22 is reduced are represented by dotted lines.

In order to display said image, a suitable voltage V2 is applied between the first electrode 22 and the second electrode 24. An electrical field is created between the first and second electrodes 22 and 24, except where marks have been written, because the electrical conductance of these marks is too small for allowing creation of an electrical field. Hence, the liquid crystal molecules of the liquid crystal layer 23 are subjected to the electrical field, except in the parts located under the marks written in the first electrode 22. As a consequence, the liquid crystal layer 23 becomes colored, except in the parts located under the written marks. Hence, the image is displayed.

The image can then be removed by simply cutting the potential difference V2. The image can be displayed again by applying again said potential difference V2 between the first and second electrodes 22 and 24.

In FIG. 4b, the liquid crystal layer 23 can be locally degraded, e.g. annealed, altered, molten, fixed, photochemically or deteriorated by means of the optical beam. A local degradation of the liquid crystal layer 23 results in the fact that the molecules in a degraded area lose their ability to rotate when a potential difference is applied between the first and second electrodes 22 and 24. Hence, degraded areas remain transparent, whatever the potential difference applied between the first and second electrodes 22 and 24. This allows recording an image in this sub-stack, by writing marks in the liquid crystal layer 23, which marks form said image. The image is then displayed by applying the potential difference V2 between the first and second electrodes 22 and 24.

It should be noted that an image might also be recorded in the display of FIG. 3, by patterning the first electrode 22 or the liquid crystal layer 23, in order to create holes, as explained in FIGS. 2a and 2b. In this case, the description of FIGS. 4a and 4b also applies.

The displays of FIG. 1a to 4b preferably comprise a color filter. Such a color filter is placed, for example, in the cover 12. As a consequence, the pre-recorded images have the color of the color filter, instead of being viewed transparent, which makes the display more attractive.

Furthermore, it is advantageous that the color filter comprises pixels having different colors. For example, the color filter comprises multiple adjacent red, green and blue pixels. Such a color filter might be manufactured by means of printing, such as offset printing. Using such a color filter allows obtaining a full color image in the display. Actually, it is possible to define the area of a pixel of the image as the sum of the areas of a red, a green and a blue adjacent pixels of the color filter. Now, it is well known that a given color is always a combination of a first part of red, a second part of green and a third part of blue. As a consequence, in order to record a pixel of an image having said given color, a first number of marks is written under the red pixel, a second number under the green and a third number under the blue pixel, in such a way that the ratio between the first, second and third number is the same as the ratio between the first, second and third parts.

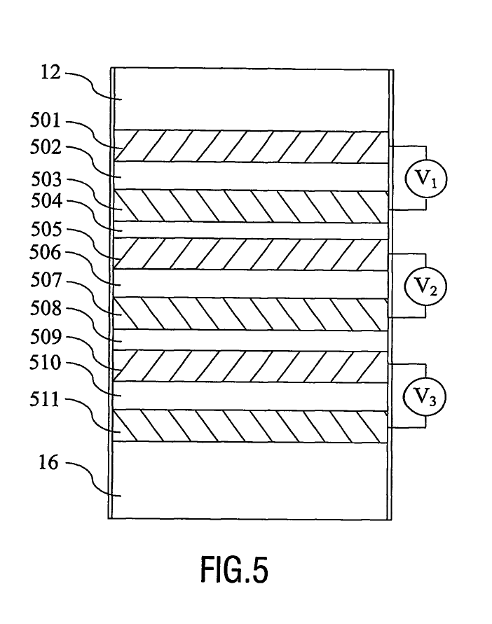

FIG. 5 shows a display comprising one image stack and three image sub-stacks. The display comprises the cover 12 and the substrate 16; a first electrochromic layer 501, a first electrolyte 502 and a first counter electrode 503, which form a first image sub-stack; a first spacer 504; a second electrochromic layer 505, a second electrolyte 506 and a second counter electrode 507, which form a second image sub-stack; a second spacer 508; a third electrochromic layer 509, a third electrolyte 510 and a third counter electrode 511, which form a third image sub-stack.

The first, second and third electrochromic layers 501, 505 and 509 comprise different electrochromic material. In the following example, the electrochromic material of the first electrochromic layer 501 is chosen to be transparent in its oxidized state, and red in its reduced state, the electrochromic material of the second electrochromic layer 505 is chosen to be transparent in its oxidized state, and green in its reduced state and the electrochromic material of the third electrochromic layer 503 is chosen to be transparent in its oxidized state, and blue in its reduced state. This allows obtaining full-color images, by applying potential differences V1, V2 and V3 between the electrochromic layer and the counter electrode of each stack.

Actually, if it is assumed that a red pixel has to be recorded in the image stack, then, a certain number of marks, corresponding to an image pixel, is written in the second and in the third image sub-stacks. Then, when an image is displayed by applying the suitable potential differences to the different sub-stacks, this pixel will appear red, because the user will see a red pixel and two transparent pixels. If it is assumed that a pixel having a color has to be recorded, which color is a combination of red and blue, a certain number of marks, corresponding to an image pixel, is written in the second image sub-stack. If it is assumed that a pixel having a color has to be recorded, which color is a combination of X red, Y green and Z blue, with X+Y+Z=1, then the desired color is obtained by writing a different number of marks per image pixel in the first, second and third image sub-stacks. For example, by writing 1/X marks in the first sub-stack, 1/Y in the second sub-stack and 1/Z in the third sub-stack, the desired color of the pixel is obtained.

As a consequence, such an image stack allows recording a full color-image. It should be noted that an image stack might comprise only two sub-stacks with different electrochromic material. In this case, the number of available colors is limited compared to the image stack of FIG. 5.

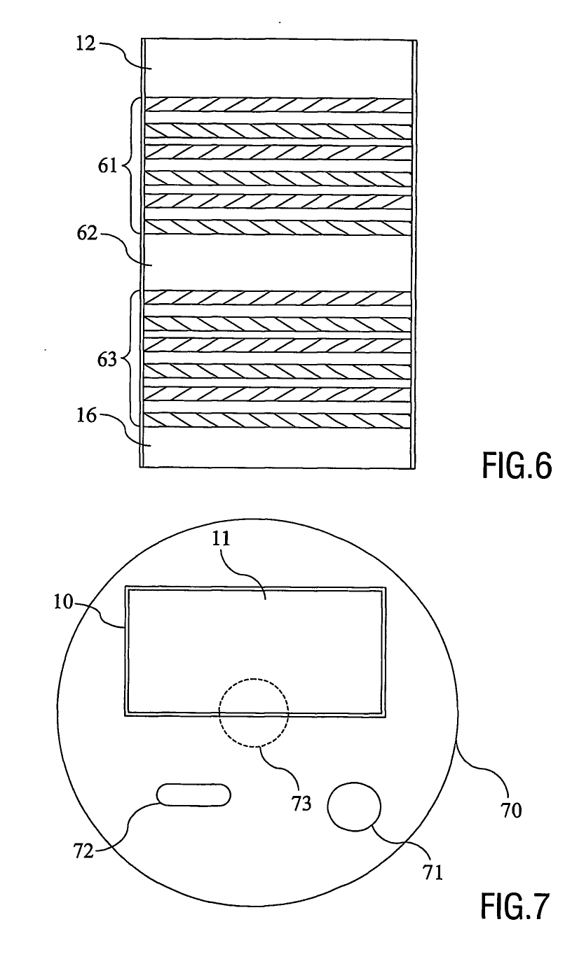

FIG. 6 shows a display comprising two image stacks. This display comprises the cover 12, the substrate 16, a first image stack 61, a spacer 62 and a second image stack 63. In this example, each image stack comprises three image sub-stacks, each comprising different optical properties. This means that two full-color images might be recorded in the display of FIG. 6. It should be noted that the description hereinafter also applies to information stacks comprising only one image sub-stacks.

Such a display is particularly advantageous, as it allows recording two different images, which can be independently displayed. As a consequence, such a display might be used, for example, as a photo frame. Two pictures are recorded in the display, which can be displayed one after the other. Of course, the number of image stacks is not limited, and a display comprising more information stacks could store more pictures.

Such a display might also be used in order to give the impression of movement. For example, a display comprising one hundred image layers could record one hundred successive images of a movie. By subsequently displaying each image, at a rate of 25 images per second for example, the movie can be played.

A display in accordance with the invention advantageously further comprises an acoustic transducer, which allows for playing sounds, such as a soundtrack of a movie.

Such a display might also be used in order to give the impression of three dimensions. Actually, when a plurality of images are simultaneously displayed, images which are close to the substrate 16 are perceived to lie behind images which are closer to the cover 12, when the display is used in a reflective way.

Of course, a display in accordance with the invention might comprise more than two image stacks. Moreover, at least one image stack might not be switchable, i.e the optical properties of its material cannot be changed by applying a potential difference. This might be the case for the last image stack of the display, i.e the image stack that lies behind the other image stacks when viewed from a user. In this last image stack, a permanent image might be recorded, which serves as background for the display. This permanent image might be complex, or might have an homogeneous color, thus giving a background color to the display.

FIG. 7 shows a cartridge for recording an image in a display in accordance with the invention. The cartridge 70 has the shape of an information carrier, which can be recorded in an optical scanning device. For example, the cartridge 70 has the shape of a CD (CD stands for Compact Disc). The cartridge 70 comprises a hole 73, in order to fix said cartridge 70 on a damper of the optical scanning device. The cartridge 70 further comprises receiving means 71 and applying means 72. The cartridge further comprises means for receiving the display 10. For example, the display 10 may be clicked into the cartridge 70.

In order to record an image in the display 10, the cartridge 70 and the display 10 are placed in an optical scanning device. The optical scanning device comprises an optical pick-up unit for focussing and tracking and an optical beam for writing marks in the display 10. The cartridge 70 and the display 10 are preferably provided with a pre-groove in order to allow for tracking.

In order to write marks in a selected image sub-stack, said marks forming an image, the optical scanning device generates a signal comprising information about the selected sub-stack. For example, an identifier of the selected sub-stack is encoded in this signal. The signal might comprise further information, such as an amplitude of a potential difference that has to be applied between two electrodes in order to change the optical properties of the material of the selected sub-stack.

This signal is, for example, a modulated signal, which is modulated as a function of the information about the selected sub-stack. Various types of modulation can be used, such as pulse modulation, analogue or digital frequency modulation, amplitude modulation or phase modulation. The signal is, for example, a modulated light generated by the optical scanning device. In this case, the receiving means are, for example, a photodiode. This signal is received by the receiving means 71 and processed by the applying means 72, which functioning is described in FIG. 8.

The cartridge 70 further comprises contacts which are adapted to connect the electrodes of the display 10, as will be explained in more detail in FIG. 8.

FIG. 8 shows the functioning of the cartridge 70. In this example, the cartridge 70 comprises six contacts for connecting the electrodes of the display 10. In the example described hereinafter, the cartridge 70 is adapted for receiving the display of FIG. 5. The cartridge 70 comprises a first contact 811 adapted to connect the first electrochromic layer 501, a second contact 812 adapted to connect the second electrochromic layer 505, a third contact 813 adapted to connect the third electrochromic layer 509, a fourth contact 814 adapted to connect the first counter electrode 503, a fifth contact 815 adapted to connect the second counter electrode 507 and a sixth contact 816 adapted to connect the third counter electrode 511.

The applying means 72 comprises decoding means 801, switch controlling means 802, an energy source 803 and voltage controlling means 804. The applying means 72 further comprises switches, each switch corresponding to a given contact 811 to 816. The decoding means 801, the switch controlling means 802 and the voltage controlling means 804 are powered by the energy source 803.

The signal generated by the optical scanning device is received by the receiving means 71. The received signal is then decoded by the decoding means 801, which then provides an identifier corresponding to the selected image sub-stack. The decoding means 801 might provide further information, such as an amplitude of the potential difference, which has to be applied between two contacts. On the basis of this identifier, the switch controlling means 802 controls the switches, so that a potential difference is applied between the contacts corresponding to the selected image sub-stack. For example, if we assume that the selected image sub-stack is the first image sub-stack of FIG. 5, the switch controlling means 802 switches on the switches corresponding to the first contact 811 and the fourth contact 814. A potential difference is then applied between contacts 811 and 814, so that the optical properties of the corresponding image sub-stack are changed which allows writing marks in said image sub-stack in order to record an image.

The energy source 803 can be a battery. This battery might be rechargeable, for example by means of a photodiode illuminated by the optical beam used for writing marks in the display 10, or by any other light source such as an additional LED (LED stands for Light Emitting Diode), or by means of an induction coil.

Alternatively, the applying means can be adapted to apply a potential difference corresponding to the received signal between the contacts. In this case, the energy source 803 is a power converter, such as a rectifier. A part of the received signal is decoded by the decoding means 801, another part is sent to the energy source 803, which converts this signal into power.

The energy source 803 might also be a combination of a rechargeable battery and a power converter. In this case, a part of the received signal is converted into power, which is used for recharging the battery.

FIG. 9 shows a cartridge for displaying images recorded in the display 10. This displaying cartridge 90 comprises addressing means 91 and a user interface 92. The displaying cartridge 90 further comprises contacts which are adapted to connect the electrodes of the display 10. These contacts are similar to the contacts depicted in FIG. 8.

By means of the user interface 92, a user selects an image to be displayed. A signal is generated, comprising information about the image sub-stack comprising the selected image. The addressing means 91, which are similar to the applying means 72 of FIGS. 7 and 8, applies a potential difference between the two electrodes of said image sub-stack. The addressing means 91 comprises a battery, which might be rechargeable. Instead of a battery, a solar cell might be used.

It should be noted that an image to be displayed might be selected directly by the addressing means 91. For example, the displaying order of images might be determined by an internal addressing algorithm, which is embedded in the addressing means 92. In this case, the user interface 92 only allows a user to start displaying the predetermined sequence of images.

It should also be noted that the cartridge 70 of FIG. 7 might be used as displaying cartridge. In this case, the cartridge 70 comprises a user interface and/or an internal addressing algorithm, as depicted in FIG. 9.

A cartridge in accordance with the invention might further comprise an acoustic transducer, which allows for playing sounds, such as a soundtrack of a movie.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A display for displaying pre-recorded images, said display comprising at least one image stack comprising at least one image sub-stack (13, 14, 15), said image sub-stack comprising a material which optical properties depend on a potential difference (V1) applied between two electrodes (13, 15), wherein said image sub-stack can be locally altered in order to record an image.

2. A display for displaying pre-recorded images, said display comprising at least one image stack comprising at least one image sub-stack, said image sub-stack comprising a material which optical properties depend on a potential difference applied between two electrodes, wherein said image sub-stack is locally altered in order to record an image which can be displayed by applying said potential difference between said two electrodes.

3. A display as claimed in claim 1, wherein said material is an electrochromic material.

4. A display as claimed in claim 3, wherein said electrochromic material has an ability to take up or release electrons, which can be locally reduced by means of an optical beam.

5. A display as claimed in claim 1, said display further comprising a color filter.

6. A display as claimed in 5, said color filter comprising pixels having different colors.

7. A display as claimed in claim 3, wherein said at least one image stack comprises at least two image sub-stacks comprising materials having different optical properties.

8. A display as claimed in claim 1, said display comprising at least two image stacks (61, 63).

9. A method for recording an image in a display as claimed in claim 1, said method comprising a step of locally altering said at least one image sub-stack in order to record an image.

10. A method for recording an image as claimed in claim 9, wherein said altering step comprises a sub-step of focusing an optical beam on the at least one image sub-stack.

11. A cartridge for recording an image in a display as claimed in claim 1, said cartridge comprising means for receiving said display, means for receiving a signal comprising information about a selected image sub-stack and means for applying a potential difference between the two electrodes of said selected image sub-stack.

12. A cartridge for displaying an image in a display as claimed in claim 2, said cartridge comprising means for receiving said display, means for selecting an image sub-stack and means for applying a potential difference between the two electrodes of the selected image sub-stack.
